(19) United States
(12) Patent Application Publication
(10) Pub. No.: US 2025/0150146 A1
(43) Pub. Date: May 8, 2025

(54) METHOD AND RADIO BASE STATION COMPRISING ANTENNAS FOR PROVIDING COVERAGE IN A CELL

(71) Applicant: Telefonaktiebolaget LM Ericsson (publ), Stockholm (SE)

(72) Inventors: Niklas JALDÉN, Enköping (SE); Anders FURUSKÄR, Stockholm (SE); Panagiota LIOLIOU, Sundbyberg (SE)

(21) Appl. No.: 18/837,222

(22) PCT Filed: Apr. 28, 2022
(86) PCT No.: PCT/SE2022/050412

§ 371 Date: Aug. 9, 2024

(30) Foreign Application Priority Data
Feb. 25, 2022 (GR) 20220100174

(51) Int. Cl. H04B 7/06; H01Q 3/12; H04W 16/28

(52) U.S. Cl. CPC H04B 7/0691; H01Q 3/12; H04W 16/28

(57) ABSTRACT

The present disclosure relates to a method performed by a radio base station for providing radio coverage in a cell, and a radio base station performing the method. In an aspect, a method performed by a radio base station for providing radio coverage in a cell is provided. The method includes establishing communication channels in a plurality of directions via a first antenna capable of performing beamforming, acquiring performance indicators for the established communication channels, and directing at least a second antenna in a selected direction based on the acquired obtained performance indicators.

### TECHNICAL FIELD

The present disclosure relates to a method performed by a radio base station for providing radio coverage in a cell, and a radio base station performing the method.

### BACKGROUND

An increasing demand for capacity in wireless networks leads to a continuous growth of the amount of hardware and number of frequency bands on existing radio sites. With the introduction of advanced antenna systems (AAS), signals are more easily directed in space to intended coverage regions as each signal may be beamformed and/or precoded differently. The direction in which to beamform signals may be determined by various types of channel state information (CSI) and the AAS may by itself sense where different types of signals should be transmitted.

This, together with the increased bandwidth of fifth generation (5G) radio AAS sites can provide a tremendous capacity boost. With legacy passive antenna systems, this is more difficult as the legacy systems do not have multiple antenna array ports and hence lack the possibility of sensing the environment to know where to receive and transmit signals.

Hence, for legacy systems it is far more important to direct the signals in the best way. Further, this tuning is often performed manually, or with the help of a few more elaborate remote electrical tilt (RET) tuning algorithms based on trial-and-error approaches where antenna tilt is adjusted and compared with previous configurations to arrive at an improved tilt configuration.

Achieving optimal performance is difficult since there is a balance between achieving adequate coverage for all connected wireless communication terminals while maintaining as low inter-cell interference as possible. This together with reluctance of an operator to re-adjust site antenna tilts blindly, with risk of deteriorating coverage in a section of the cell where coverage previously existed, has led operators to maintain settings of the passive antenna systems, even after deploying additional bands for boosting site capacity. Further, the traffic pattern of a network continuously changes which makes trial-and-error antenna tuning difficult and also results in convergence issues using trial-and-error approaches.

### SUMMARY

One objective is to solve, or at least mitigate, this problem in the art and thus to provide an improved method of providing radio coverage in a cell.

This objective is attained in a first aspect by a method performed by a radio base station for providing radio coverage in a cell. The method comprises establishing communication channels in a plurality of directions via a first antenna capable of performing beamforming, acquiring performance indicators for the established communication channels, and directing at least a second antenna in a selected direction based on the acquired obtained performance indicators.

This objective is attained in a second aspect by a radio base station configured to provide radio coverage in a cell. The radio base station comprises a processing unit and a memory, the memory containing instructions executable by the processing unit, whereby the radio base station is operative to establish communication channels in a plurality of directions via a first antenna capable of performing beamforming, acquire performance indicators for the established communication channels, and to direct at least a second antenna in a selected direction based on the acquired obtained performance indicators.

Advantageously, the first antenna is used as a sensor for acquiring performance indicators configured to indicate radio quality in various directions of the cell being served by the base station. These acquired performance indicators are then used to direct the second antenna in a preferred direction to improve radio coverage in the cell. For instance, while the second antenna currently may be directed in e.g. a north-east direction of the cell, the acquired performance indicators may indicate that coverage rather should be improved in a north-west section of the cell and that the second antenna thus should be redirected from the north-east section of the cell 101 to the north-west section to this effect.

In an embodiment, the method comprises transmitting data to wireless communication devices with which the communication channels are established, receiving a response to the transmitted data from each wireless communication device, wherein the acquiring of performance indicators for the established communication channels comprises determining the performance indicators from the received responses.

In an embodiment, the method comprises receiving data from each wireless communication device with which the communication channels are established, wherein the acquiring of performance indicators for the established communication channels comprises determining the performance indicators from the received data.

In an embodiment, the method comprises determining whether or not at least one of the acquired performance indicators is below a performance threshold, and if so the directing of the second antenna in a selected direction based on the acquired obtained performance indicators comprises directing the second antenna in a direction associated with said at least one acquired performance indicator.

In an embodiment, the method comprises performing a weighting of the acquired performance indicators for all directions; wherein the directing of the second antenna in a selected direction based on the acquired obtained performance indicators comprises directing the second antenna in a direction indicated by the performed weighting to have the worst performance.

In an embodiment, the directing of the second antenna being performed by directing the second antenna based on the acquired obtained performance indicators towards a cell edge for improving the coverage at the cell edge.

In an embodiment, the first antenna is configured to operate at a higher frequency band than the second antenna.

In an embodiment, the method comprises acquiring information indicating interference occurring in a neighbouring cell, and redirecting the second antenna in response to the acquired information to decrease the interference caused to the neighbouring cell.

The objective is attained in a third aspect by a computer program comprising computer-executable instructions for causing a radio base station to perform the method of the first aspect when the computer-executable instructions are executed on a processing unit included in the radio base station

The objective is attained in a fourth aspect by a computer program product comprising a computer readable medium, the computer readable medium having the computer program according to the third aspect embodied thereon.

Generally, all terms used in the claims are to be interpreted according to their ordinary meaning in the technical field, unless explicitly defined otherwise herein. All references to “a/an/the element, apparatus, component, means, step, etc.” are to be interpreted openly as referring to at least one instance of the element, apparatus, component, means, step, etc., unless explicitly stated otherwise. The steps of any method disclosed herein do not have to be performed in the exact order disclosed, unless explicitly stated.

### BRIEF DESCRIPTION OF THE DRAWINGS

Aspects and embodiments are now described, by way of example, with reference to the accompanying drawings, in which:

FIGS. 1 and 2 illustrate a commonly used antenna tilting strategy for a radio network site;

FIG. 3 illustrates a radio base station configured to provide radio coverage in a cell comprising a plurality of wireless communication devices according to an embodiment;

FIG. 4 shows a flowchart illustrating a method performed by a radio base station for providing radio coverage in a cell according to an embodiment;

FIGS. 5 and 6 illustrate acquiring performance indicators in a plurality of directions according to an embodiment;

FIG. 7 shows a flowchart illustrating a method performed by a radio base station for providing radio coverage in a cell according to another embodiment;

FIG. 8 shows a flowchart illustrating a method performed by a radio base station for providing radio coverage in a cell according to a further embodiment;

FIG. 9 illustrates a radio base station antenna being redirected according to an embodiment;

FIG. 10 shows a flowchart illustrating a method performed by a radio base station for providing radio coverage in a cell according to yet another embodiment; and

FIG. 11 illustrates a radio base station according to an embodiment.

### DETAILED DESCRIPTION

The aspects of the present disclosure will now be described more fully hereinafter with reference to the accompanying drawings, in which certain embodiments of the invention are shown.

These aspects may, however, be embodied in many different forms and should not be construed as limiting; rather, these embodiments are provided by way of example so that this disclosure will be thorough and complete, and to fully convey the scope of all aspects of invention to those skilled in the art. Like numbers refer to like elements throughout the description.

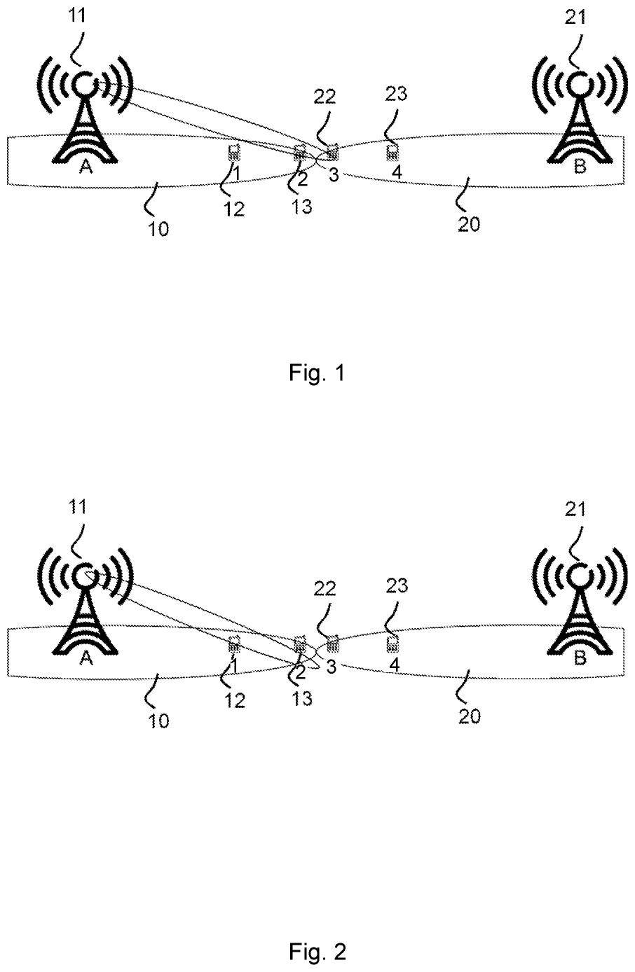

FIGS. 1 and 2 illustrate a commonly used antenna tilting strategy for a radio network site. Consider a simplified setup with a first cell 10 and a second cell 20. A first radio base station 11 (RBS) serving the first cell 10 intends to provide coverage to a first wireless communication device 12 and a second wireless communication device 13, while a second RBS 21 serving the second cell 20 provides coverage to a third wireless communication device 22 and a fourth wireless communication device 23. The wireless communication devices are commonly referred to as User Equipment (UE) and may be embodied in the form of smart phones, tablets, connected vehicles, etc.

As can be seen, in the first cell 10, the first UE 12 is located closer to the first RBS 11 and is therefore typically not subjected to as high path loss as the second UE 13.

Hence, in order to provide an adequate (average) coverage in the first cell 10, the first RBS 11 should tilt its antenna(s) such that the second UE 13 achieves sufficiently high antenna gain. In a legacy setup without AAS and UE specific beamforming, the first RBS 11 will perform transmission in this beam regardless of whether transmitted data is intended for the first UE 12 or the second UE 13.

A problem with this approach is that the third UE 22 (which is closely located to the second UE 13) is subjected to interference by the data transmitted by the first RBS 11. Correspondingly, the second UE 13 is subjected to interference by the data transmitted by the second RBS 21 should the second RBS 21 employ the same tilting strategy.

As illustrated in FIG. 2, in order to mitigate interference and improve overall system performance for all users in the system, the first RBS 11 and the second RBS 21 will direct their antenna(s) away from the second UE 13 and the third UE 22, respectively, to cause less interference. This tilting is however suboptimal from a coverage perspective.

Any higher-frequency bands being added, even with AAS and the possibility for UE specific beamforming, will typically suffer from higher path loss making the efficiency of such bands relatively low for long-distance cell edge communication.

Cell edge users could potentially be served by the previously existing lower bands. However, there is no guarantee that those bands or systems are tuned in a way to optimally serve the cell edge users in an upgraded legacy network since as highlighted above, the legacy systems are tuned to provide best overall system performance before the new bands are added.

Further, the locations of these cell edge users are not known for the passive antenna systems, making adjustments even more difficult.

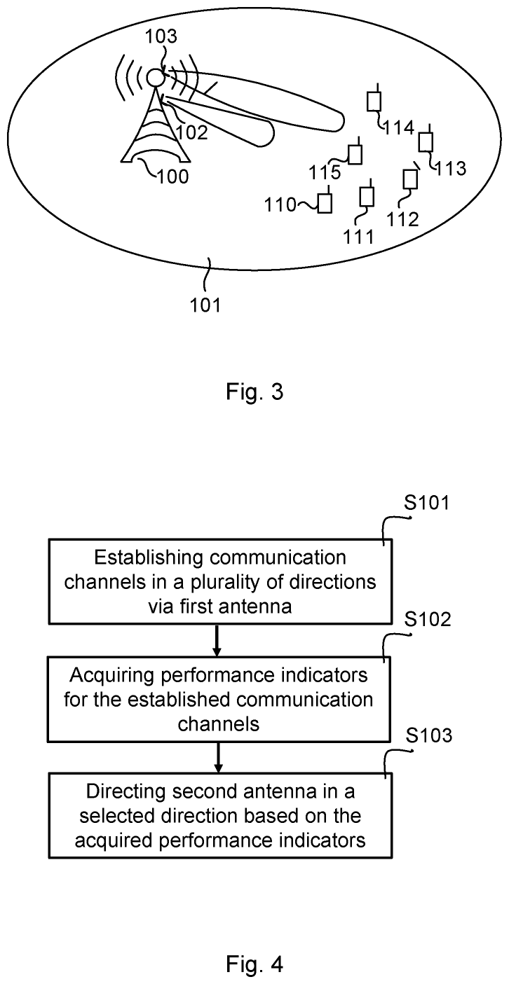

FIG. 3 illustrates an RBS 100 configured to provide radio coverage in a cell 101 comprising a plurality of UEs 110-115 according to an embodiment. As is understood, a radio cell may in practice comprises hundreds or even thousands of UEs.

The RBS 100 is equipped with at least one first antenna 102 capable of performing beamforming. Thus, the first antenna 102 is capable of establishing communication channels with the UEs 110-115 in a plurality of directions by means of performing beamforming for providing radio coverage in the cell 101.

Further, the RS 100 comprises at least one second antenna 103 capable of being directed in different directions in the cell 101. Typically (but not necessarily), the first antenna 102 operates at a higher band than the second antenna 103. For instance, the second antenna 103 may operate at an 1800 MHz band, while the first antenna 102 operates at a 3.5 GHz band. Generally, the directing is relatively slow and not performed e.g. on a Transmission Time Interval (TTI) level.

FIG. 4 shows a flowchart illustrating a method performed by the RBS 100 for providing radio coverage in the cell 101 according to an embodiment.

Now, in a first step S101, the RBS 100 establishes communication channels with a number of the UEs 110-115 in a plurality of directions via the first antenna 102.

Thereafter, in step S102, the antenna system 100 acquires performance indicators for the established communication channels in the various directions.

In one embodiment, the RBS 100 may transmit data to the UEs 110-115 over the established communication channels and receive a response from the UE with which a channel is established, from which response a performance indicator is determined for each channel such as e.g. bit error rate, degree of scattering or fading, path loss, data throughput, etc.

In another embodiment, the UEs 110-115 with which the communication channels are established may send training sequences from which the RBS 100 may determine channel state information (CSI) for each channel. Similar to the previously mentioned embodiment, such CSI may include performance indicators such as e.g. bit error rate, degree of scattering or fading, path loss, etc.

Further, in an embodiment, delay from the RBS 100 to the UEs 110-115 are taken into account when determining performance indicators using e.g. information indicating time of arrival of signals.

Thus, the performance indicators may indicate performance in uplink, downlink or both.

Based on the acquired performance indicators, the RBS 100 directs the second antenna 103 in a selected direction of the radio cell 101.

For instance, the antenna system 100 may conclude from the acquired performance indicators that a particular section of the cell 101 is indicated to have poor coverage—as indicated by UEs in that section with which channels are established—and direct the second antenna 103 towards that particular section in order to improve the radio coverage.

Advantageously, the first antenna 102 is used as a sensor for acquiring performance indicators configured to indicate radio quality in various directions of the cell 101. These acquired performance indicators are then used to direct the second antenna 103 in a preferred direction to improve radio coverage in the cell 101. For instance, while the second antenna 103 currently may be directed in e.g. a north-east direction of the cell 101, the acquired performance indicators may indicate that coverage rather should be improved in a north-west section of the cell 101 and that the second antenna 103 thus should be redirected from the north-east section of the cell 101 to the north-west section to this effect. The vertical movement of the second antenna 103 may be controlled based on RET functionality, while the azimuthal movement of the second antenna generally is performed by some motor allowing horizontal adjustment.

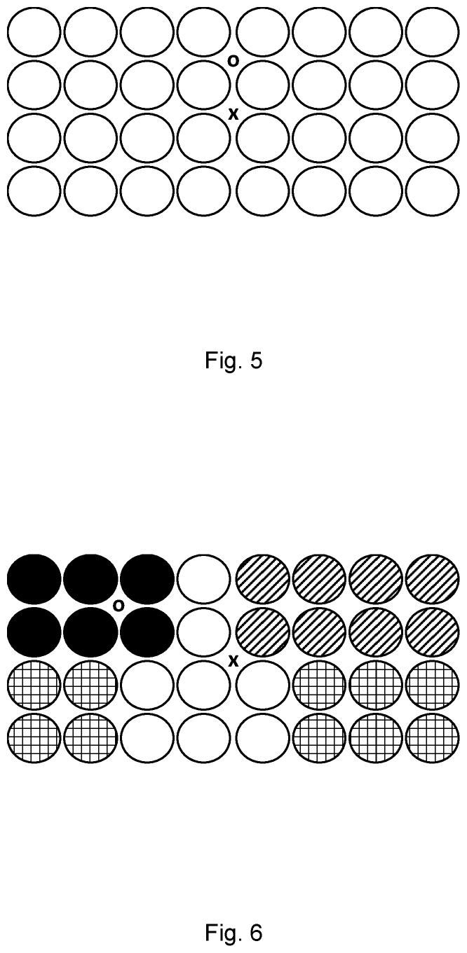

This is illustrated in more detail with reference to FIG. 5, which illustrates that the first antenna 102 may be controlled by the RBS 100 to apply beamforming for establishing communication channels in a total of 32 different directions, i.e. four possible elevational (vertical) directions and eighth azimuth (horizontal) directions. As is understood, the RBS 100 is via the first antenna 102 typically capable of simultaneously establishing communication channels in each one of the 32 directions for acquiring performance indicators for the established channels. In practice, the area covered by the 32 directions may make up the complete coverage area of the cell 101.

As is understood, beamforming may include both transmit beamforming and receive beamforming including e.g. maximum-ratio combining (MRC) and interference rejection combining (IRC). Advantageously, the beamforming capability enables spatial observability.

In the illustration of FIG. 5, the second antenna 103 is currently directed in a direction indicated by “x”, while an optimal, or at least more preferred, direction is indicated by “o”. However, the antenna system 100 is at this point not aware of the preferred direction.

Thus, as previously described with reference to FIG. 4, the RBS 100 establishes communication channels in a plurality of directions via the first antenna 102 in step S101, in this particular example 32 directions. As is understood, the granularity of the directions in which the first antenna 102 is controlled to transmit and/or receive depends on the technology used, and may in practice be seamless where a more or less infinite number of directions may be employed for covering the cell 101.

Thereafter in step S102, the RBS 100 acquires performance indicators for each established channel, for instance by transmitting data to a UE with which the channel is established and receiving a response thereto from which a performance indicator such as e.g. data throughput may be determined by the RBS 100. As an example, the RBS 100 may send data at different bit rates and the UE respond with an Ack/Nack depending on whether or not the data is correctly received at the UE at the respective rate. As a result, the performance indicator may e.g. indicate an average bitrate of each direction, or minimum bitrate that a UE is capable of receiving.

Advantageously, a performance indicator may hence be associated with each of the 32 directions illustrated in FIG. 5.

FIG. 6 illustrates that after the performance indicators have been acquired for the 32 directions of the first antenna 102, the RBS 100 has access to a solid dataset from which a cell coverage assessment may be made.

In FIG. 6, the six directions indicated in black are assessed to have the worst performance, while the eighth directions indicated with stripes has the second-worst performance. Correspondingly, the eighth directions indicated in white provides the best performance while the ten chequered directions have the next-best performance.

Again, the current direction of the second antenna 103 is indicated with an “x”. As can be concluded from the performance indicators of FIG. 6, the second antenna 103 is currently directed in a direction where the performance already is high due to coverage provided by the first antenna 102, and thus may not be the preferred direction into which the second antenna 103 should be directed.

Rather, as can be concluded from the acquired performance indicators, the second antenna 103 should be directed in the direction indicted with “o” since the first antenna 102 provides a poorer coverage in that section of the cell 101, and the RBS 100 will hence redirect the second antenna 103 from pointing towards direction “x” to pointing towards direction “o” in step S103 in order to improve radio coverage in the section of the cell around the position indicated “o”. In other words, the RBS 100 will slightly elevate the second antenna 103 and redirect the second antenna 103 in a westerly direction to move from current position “x” to preferred position “o”.

Advantageously, cell-edge users typically having the worst performance may be targeted by the second antenna 103, which generally will be operated at a lower band (such as 1800 MHZ) thus having a greater reach, while users located towards a centre of the cell 101 may be served by the first antenna 102 which generally will be operated at a higher band, such as 3.5 GHz).

Hence, the lower-band antenna settings are tuned in a way such that the performance for the worst (cell-edge) users is boosted, which improves overall cell capacity and coverage.

As is understood, as compared to prior art, which commonly utilize blind trial-and-error approaches based on RET-adapting algorithms (“Remote Electrical Tilt”), the proposed approach provides for well-informed decision being taken by the RBS 100.

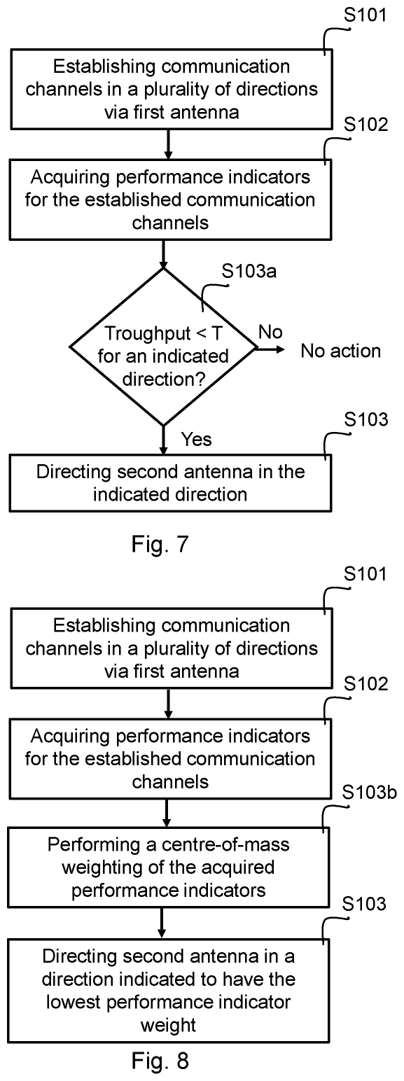

FIG. 7 shows a flowchart illustrating a method performed by the RBS 100 for providing radio coverage in the cell 101 according to a further embodiment.

Similar to the embodiment described with reference to FIG. 4, in first step S101, the RBS 100 establishes communication channels with a number of the UEs 110-115 in a plurality of directions via the first antenna 102.

Thereafter, in step S102, the RBS 100 acquires performance indicators for the established communication channels in the various directions.

As previously discussed, the RBS 100 may transmit data to the UEs over the established communication channels and receive a response from each UE with which a channel is established, from which response a performance indicator is determined for each channel such as e.g. data throughput.

In this embodiment, the RBS 100 determines in step S103a whether or not the acquired indication of data throughput is below a predetermined data throughput threshold T for one or more directions. If that is not the case, the RBS 100 may determine that the cell coverage currently is adequate and that no further actions is to be taken at this stage.

However, with reference to FIG. 6, if the RBS 100 determines that data throughput indeed is below the data throughput threshold T—for instance for the section of the cell 100 formed by the six directions illustrated in black where the coverage thus is indicated to be poor—the RBS 100 will redirect the second antenna 103 towards that section in step S103, for example to point towards position “o”.

FIG. 8 illustrates an alternative embodiment where rather than performing a comparison to a performance threshold T, the RBS 100 computes a suitable function based on the acquired performance indicators for all directions in step S103b and directs the second antenna 103 towards a section of the cell 101 indicated by for instance a performed centre-of-mass weighting having the worst performance, in this case the lowest data throughput, or by computing a weighted sum function where weights are selected depending on how much emphasis should be placed on each performance indicator.

In a further embodiment, the procedure is repeated for multiple bands. E.g., starting with a lowest band (say 800 MHZ), and the continuing with a next lowest band (say 1800 MHZ), assuming that a subset of users have been taken care of by the lowest band, which are then removed when determining the direction for the next lowest band. Intuitively, the lowest band is redirected to take care of the very worst users, and the next lowest band is redirected to take care of the next worst users etc.

In another embodiment, the RBS 100 acquires information indicating any interference occurring in a neighbouring cell as a result of the directing of the antennas 102, 103 of the RBS 100.

For instance, the RBS 100 may communicate with the neighbouring RBS over an X2 interface in order to acquire the interference information, or with a core network node such as a Mobility Management Entity (MME) serving the neighbouring RBS.

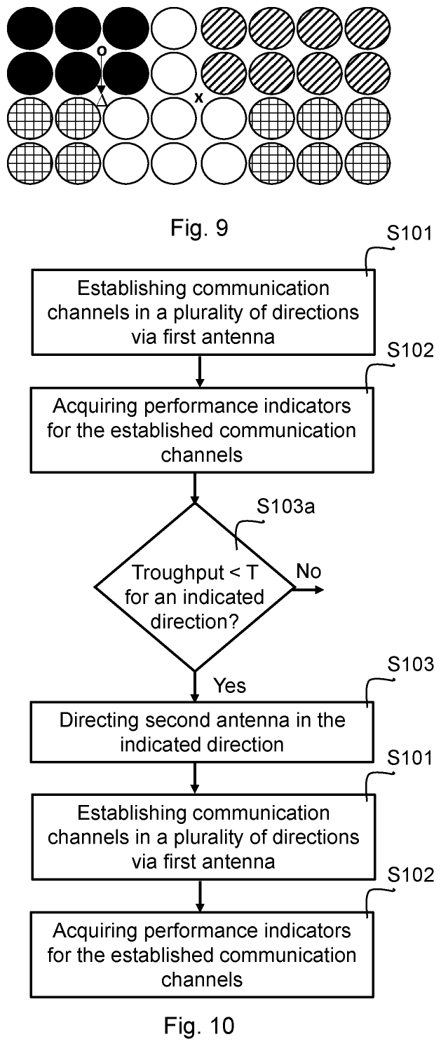

FIG. 9 illustrates that the second antenna 103 is redirected from position “x” to position “o” as previously discussed with reference to FIG. 6. However, in this embodiment with further reference to FIG. 10, after the second antenna 103 has been redirected in step S103, the RBS 100 acquires information e.g. from the neighbouring RBS via the X2 interface indicating that the neighbouring cell suffers from cell-edge interference due to the second antenna 103 being directed towards position “o”.

In response to the acquired interference information, the RBS 100 slightly redirects the second antenna 103 from pointing in direction “o” to pointing in a new direction “Δ”. Typically (but not necessarily), the second antenna 103 is lowered to avoid causing interference—or at least decreasing the interference—to the neighbouring cell, while still advantageously improving coverage at the cell-edge of the cell 100.

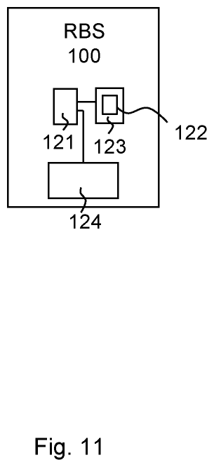

FIG. 11 illustrates an RBS 100 configured to provide radio coverage in a cell according to an embodiment, where the steps of the method performed by the RBS 100 in practice are performed by a processing unit 121 embodied in the form of one or more microprocessors arranged to execute a computer program 122 downloaded to a storage medium 123 associated with the microprocessor, such as a Random Access Memory (RAM), a Flash memory or a hard disk drive. The processing unit 121 is arranged to cause the RBS 100 to carry out the method according to embodiments when the appropriate computer program 122 comprising computer-executable instructions is downloaded to the storage medium 123 and executed by the processing unit 121. The storage medium 123 may also be a computer program product comprising the computer program 122. Alternatively, the computer program 122 may be transferred to the storage medium 123 by means of a suitable computer program product, such as a Digital Versatile Disc (DVD) or a memory stick. As a further alternative, the computer program 122 may be downloaded to the storage medium 123 over a network. The processing unit 121 may alternatively be embodied in the form of a digital signal processor (DSP), an application specific integrated circuit (ASIC), a field-programmable gate array (FPGA), a complex programmable logic device (CPLD), etc. The RBS 100 further comprises a communication interface 124 (wired and/or wireless) over which the RBS 100 is configured to transmit and receive data.

The aspects of the present disclosure have mainly been described above with reference to a few embodiments and examples thereof. However, as is readily appreciated by a person skilled in the art, other embodiments than the ones disclosed above are equally possible within the scope of the invention, as defined by the appended patent claims.

Thus, while various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

1. A method performed by a radio base station for providing radio coverage in a cell, comprising:
establishing communication channels in a plurality of directions via a first antenna capable of performing beamforming;
acquiring performance indicators for the established communication channels; and
directing at least a second antenna in a selected direction based on the acquired obtained performance indicators.

2. The method of claim 1, further comprising:
transmitting data to wireless communication devices with which the communication channels are established; and
receiving a response to the transmitted data from each wireless communication device; wherein the acquiring of performance indicators for the established communication channels comprises:
determining the performance indicators from the received responses.

3. The method of claim 1, further comprising:
receiving data from each wireless communication device with which the communication channels are established, wherein the acquiring of performance indicators for the established communication channels comprises:
determining the performance indicators from the received data.

4. The method of claim 1, further comprising:
determining whether or not at least one of the acquired performance indicators is below a performance threshold; and if so the directing of the second antenna in a selected direction based on the acquired obtained performance indicators comprises:
directing the second antenna in a direction associated with said at least one acquired performance indicator.

5. The method of claim 1, further comprising:
performing a weighting of the acquired performance indicators for all directions;
wherein the directing of the second antenna in a selected direction based on the acquired obtained performance indicators comprises:
directing the second antenna in a direction indicated by the performed weighting to have the worst performance.

6. The method of claim 1, the directing of the second antenna being performed by directing the second antenna based on the acquired obtained performance indicators towards a cell edge for improving the coverage at the cell edge.

7. The method of claim 1, the first antenna being configured to operate at a higher frequency band than the second antenna.

8. The method of claim 1, further comprising:
acquiring information indicating interference occurring in a neighbouring cell; and
redirecting the second antenna in response to the acquired information to decrease the interference caused to the neighbouring cell.

9. (canceled)

10. A computer program product comprising a non-transitory computer readable medium comprising computer-executable instructions to be executed by a processor of a radio base station, whereby execution of the computer-executable instructions causes the radio base station to perform operations comprising:
establish communication channels in a plurality of directions via a first antenna capable of performing beamforming;
acquire performance indicators for the established communication channels; and
direct at least a second antenna in a selected direction based on the acquired obtained performance indicators.

11. A radio base station configured to provide radio coverage in a cell, comprising a processing unit and a memory, said memory containing instructions executable by said processing unit, whereby the radio base station is operative to:
establish communication channels in a plurality of directions via a first antenna capable of performing beamforming;
acquire performance indicators for the established communication channels; and
direct at least a second antenna in a selected direction based on the acquired obtained performance indicators.

12. The radio base station of claim 11, further being operative to:
transmit data to wireless communication devices with which the communication channels are established; and
receive a response to the transmitted data from each wireless communication device; and being operative to, when acquiring the performance indicators for the established communication channels:
determine the performance indicators from the received responses.

13. The radio base station of claim 11, further being operative to:
receive data from each wireless communication device with which the communication channels are established; and being operative to, when acquiring the performance indicators for the established communication channels:
determine the performance indicators from the received data.

14. The radio base station of claim 11, further being operative to:
determine whether or not at least one of the acquired performance indicators is below a performance threshold; and if so being operative to, when directing the second antenna in a selected direction based on the acquired obtained performance indicators:
direct the second antenna in a direction associated with said at least one acquired performance indicator.

15. The radio base station of claim 11, further being operative to:
perform a weighting of the acquired performance indicators for all directions; and, when directing the second antenna in a selected direction based on the acquired obtained performance indicators:
direct the second antenna in a direction indicated by the performed weighting to have the worst performance.

16. The radio base station of claim 11, further being operative to, when directing the second antenna:
direct the second antenna based on the acquired obtained performance indicators towards a cell edge for improving the coverage at the cell edge.

17. The radio base station of claim 11, the first antenna being configured to operate at a higher frequency band than the second antenna.

18. The radio base station of claim 11, further being operative to:
acquire information indicating interference occurring in a neighbouring cell; and
redirect the second antenna in response to the acquired information to decrease the interference caused to the neighbouring cell.

19. The computer program product of claim 10, whereby execution of the computer-executable instructions causes the radio base station to perform further operations comprising:
transmit data to wireless communication devices with which the communication channels are established; and
receive a response to the transmitted data from each wireless communication device;
wherein acquire of performance indicators for the established communication channels comprises:
determine the performance indicators from the received responses.

20. The computer program product of claim 10, whereby execution of the computer-executable instructions causes the radio base station to perform further operations comprising:
receive data from each wireless communication device with which the communication channels are established, wherein acquire of performance indicators for the established communication channels comprises:
determine the performance indicators from the received data.

21. The computer program product of claim 10, whereby execution of the computer-executable instructions causes the radio base station to perform further operations comprising:
determine whether or not at least one of the acquired performance indicators is below a performance threshold; and if so the direct the second antenna in a selected direction based on the acquired obtained performance indicators comprises:
direct the second antenna in a direction associated with said at least one acquired performance indicator.
